(19) United States
(12) Patent Application Publication
(10) Pub. No.: US 2017/0044927 A1
(43) Pub. Date: Feb. 16, 2017

(54) LOCK-UP PREVENTION VANE FOR VARIABLE GEOMETRY TURBOCHARGER

(71) Applicant: BorgWarner Inc., Auburn Hills, MI (US)

(72) Inventor: ELIAS ALAN MORGAN, LEICESTER, NC (US)

(21) Appl. No.: 15/306,518

(22) PCT Filed: Apr. 20, 2015
(86) PCT No.: PCT/US15/26615

§ 371 Date: Oct. 25, 2016

Related U.S. Application Data
(60) Provisional application No. 61/986,505, filed on Apr. 30, 2014.

(51) Int. Cl. F01D 17/16; F02B 37/24; F01D 11/12

(52) U.S. Cl. CPC F01D 17/165; F01D 11/122; F02B 37/24; F05D 2220/40; F05D 2240/121; F05D 2240/122

(57) ABSTRACT

A turbocharger includes a variable geometry turbine (1). The turbine includes a turbine wheel (12) disposed in the turbine housing (4) between the volute (10) and the fluid outlet (8), and a first vane ring (80) and a second vane ring (90) disposed between the volute (10) and the turbine wheel (12). The vanes (30) are each pivotably supported between the first and second vane rings (80, 90). Each vane (30) includes opposed side faces (44, 46), a cavity (48, 50) formed in one or both of the side faces (44, 46), and an abradable insert (52, 56) disposed in the cavity (48, 50). The insert (52, 56) protrudes outward from the cavity (48, 50) whereby a minimal clearance is established between the vane side face (44, 46) and a corresponding facing surface (82, 92) of the first vane ring (80) and the second vane ring (90).

### CROSS-REFERENCE TO RELATED APPLICATIONS

This application claims priority to and all the benefits of U.S. Provisional Application No. 61/986,505, filed on Apr. 30, 2014, and entitled “Lock-Up Prevention Vane For Variable Geometry Turbocharger,” which is incorporated herein by reference.

### FIELD OF THE INVENTION

Embodiments are generally related to turbochargers and, more particularly, to abradable guide vanes for variable turbine geometry turbochargers.

### BACKGROUND

Exhaust gas turbochargers are provided on an engine to deliver air to the engine intake at a greater density than would be possible in a normal aspirated configuration. This allows more fuel to be combusted, thus boosting the engine's horsepower without significantly increasing engine weight.

Generally, an exhaust gas turbocharger includes a turbine section and a compressor section, and uses the exhaust flow from the engine exhaust manifold, which enters the turbine section at a turbine inlet, to drive a turbine wheel located in the turbine housing. The urbine wheel drives a compressor wheel located in the compressor section via a shaft that extends between the sections. Air compressed by the compressor section is then provided to the engine intake as described above.

The compressor section of the turbocharger includes the compressor wheel and its associated compressor housing. Filtered air is drawn axially into a compressor air inlet which defines a passage extending axially to the compressor wheel. Rotation of the compressor wheel forces pressurized air flow radially outwardly from the compressor wheel into a compressor volute for subsequent pressurization and flow to the engine.

### SUMMARY

In some aspects, a variable geometry turbine includes a turbine housing that defines a volute and a fluid outlet; a turbine wheel disposed in the turbine housing between the volute and the fluid outlet; a first vane ring and a second vane ring disposed between the volute and the turbine wheel such that a fluid flow passageway is defined between a surface of the first vane ring and a surface of the second vane ring, and vanes that are each pivotably supported between the surface of the first vane ring and the surface of the second vane ring. Each vane includes opposed side faces, a cavity formed in one of the side faces, and an abradable insert disposed in the cavity, the insert protruding outward from the cavity whereby a minimal clearance is established between the one of the side faces and a corresponding one of the surface of the first vane ring and the surface of the second vane ring.

The variable geometry turbine may include one or more of the following features: Each vane includes a cavity in each of the opposed side faces, and an outwardly protruding abradable insert is disposed in each cavity. The cavity has a peripheral shape such that when the vane is seen in side view, the peripheral shape of the cavity corresponds to the peripheral shape of at least a portion of the vane. Each vane includes a post that extends outward from the one of the opposed side faces, the cavity is disposed between the post and a leading edge of the vane, a second cavity is disposed between the post and a trailing edge of the vane, and a second abradable insert is disposed in the second cavity. The insert is configured to conform to the shape of the cavity such that the cavity is filled by the insert, and the insert includes a ridge that extends outward from an outward-facing surface of the insert. A peripheral edge of the outward-facing surface of the insert lies flush with the one of the side faces of the vane. The ridge is elongated and lies on a line that extends between a leading edge of the vane and a trailing edge of the vane. The ridge is spaced apart from a peripheral edge of the outward-facing surface of the insert. The portion of the insert corresponding to the ridge is formed of a first material, and a remainder of the insert is formed of a second material, where the first material is different from the second material. The ridge protrudes outwardly to a lesser extent in locations adjacent to a leading edge of the vane or a trailing edge of the vane when compared to an extent of outward protrusion in a region midway between the leading edge of the vane and the trailing edge of the vane.

In some aspects, a turbocharger includes a variable geometry turbine and a compressor having a compressor wheel. The turbine includes a turbine housing that defines a volute and a fluid outlet; a turbine wheel disposed in the turbine housing between the volute and the fluid outlet, the turbine wheel connected to the compressor wheel via a shaft; a first vane ring and a second vane ring disposed between the volute and the turbine wheel such that a fluid flow passageway is defined between a surface of the first vane ring and a surface of the second vane ring, and vanes that are each pivotably supported between the surface of the first vane ring and the surface of the second vane ring. Each vane includes opposed side faces, a cavity formed in one of the side faces, and an abradable insert disposed in the cavity, the insert protruding outward from the cavity whereby a minimal clearance is established between the one of the side faces and a corresponding one of the surface of the first vane ring and the surface of the second vane ring.

In some aspects, embodiments are directed to turbochargers having vane packs for varying the turbine geometry that are configured to minimize the clearance between vane side surfaces and the confronting inner surfaces of the vane rings in the vane pack while accommodating thermal expansion and/or creep of the turbocharger components due to high temperature operating conditions. For example, the vane side surfaces are formed having a cavity, and an abradable insert is disposed in, and protrudes outwardly from, the cavity toward the confronting inner surfaces of the vane rings. As a result, a very small or nil clearance can be established between the vanes and the confronting inner surfaces of the vane rings without interfering with the proper function of the vanes during turbocharger operation, whereby exhaust gas leakage along the vane side faces is reduced or eliminated, and the efficiency of the turbocharger is increased.

### BRIEF DESCRIPTION OF THE DRAWINGS

FIG. 1 is a cross-sectional view of a variable geometry turbocharger.

FIG. 2 is a perspective view of a vane of the variable geometry turbocharger of FIG. 1.

FIG. 3 is a view of the second side face of the vane of FIG. 2.

FIG. 4 is an exploded perspective view of the vane of FIG. 2.

FIG. 5 is a second flow surface-side view of the vane of FIG. 2.

FIG. 6 is an alternative embodiment vane.

FIG. 7 is another alternative embodiment vane.

### DETAILED DESCRIPTION

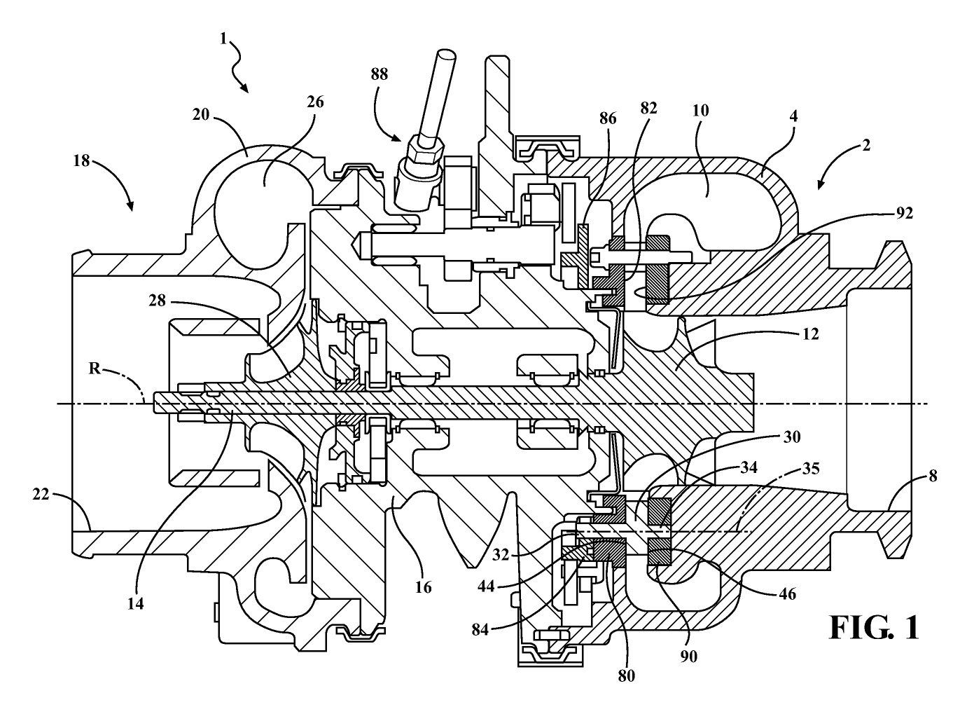

Referring to FIG. 1, an exhaust gas turbocharger 1 includes a turbine section 2, the compressor section 18, and a center bearing housing 16 disposed between and connecting the compressor section 18 to the turbine section 2. The turbine section 2 includes a turbine housing 4 that defines an exhaust gas inlet (not shown), an exhaust gas outlet 8, and a turbine volute 10 disposed in the fluid path between the exhaust gas inlet and the exhaust gas outlet 8. A turbine wheel 12 is disposed in the turbine housing 4 between the turbine volute 10 and the exhaust gas outlet 8. A shaft 14 is connected to the turbine wheel 12, is supported for rotation about a rotational axis R within in the bearing housing 16, and extends into the compressor section 18. The compressor section 18 includes a compressor housing 20 that defines an axially-extending air inlet 22, an air outlet (not shown), and a compressor volute 26. A compressor wheel 28 is disposed in the compressor housing 20 between the air inlet 22 and the compressor volute 26, and is connected to the shaft 14.

In use, the turbine wheel 12 in the turbine housing 4 is rotatably driven by an inflow of exhaust gas supplied from the exhaust manifold of an engine (not shown). Since the shaft 14 connects the turbine wheel 12 to the compressor wheel 28 in the compressor housing 20, the rotation of the turbine wheel 12 causes rotation of the compressor wheel 28. As the compressor wheel 28 rotates, it increases the air mass flow rate, airflow density and air pressure delivered to the engine's cylinders via an outflow from the compressor air outlet, which is connected to the engine's air intake manifold.

The turbocharger 1 is a variable geometry turbocharger (VGT). In particular, the turbine section 2 includes a plurality of pivotable vanes 30 to control the flow of exhaust gas that impinges on the turbine wheel 12 and control the power of the turbine section 2. The vanes 30 also therefore control the pressure ratio generated by the compressor section 18. In engines that control the production of NOx by the use of High Pressure Exhaust Gas Recirculation (HP EGR) techniques, the vanes 30 also provide a means for controlling and generating exhaust back pressure.

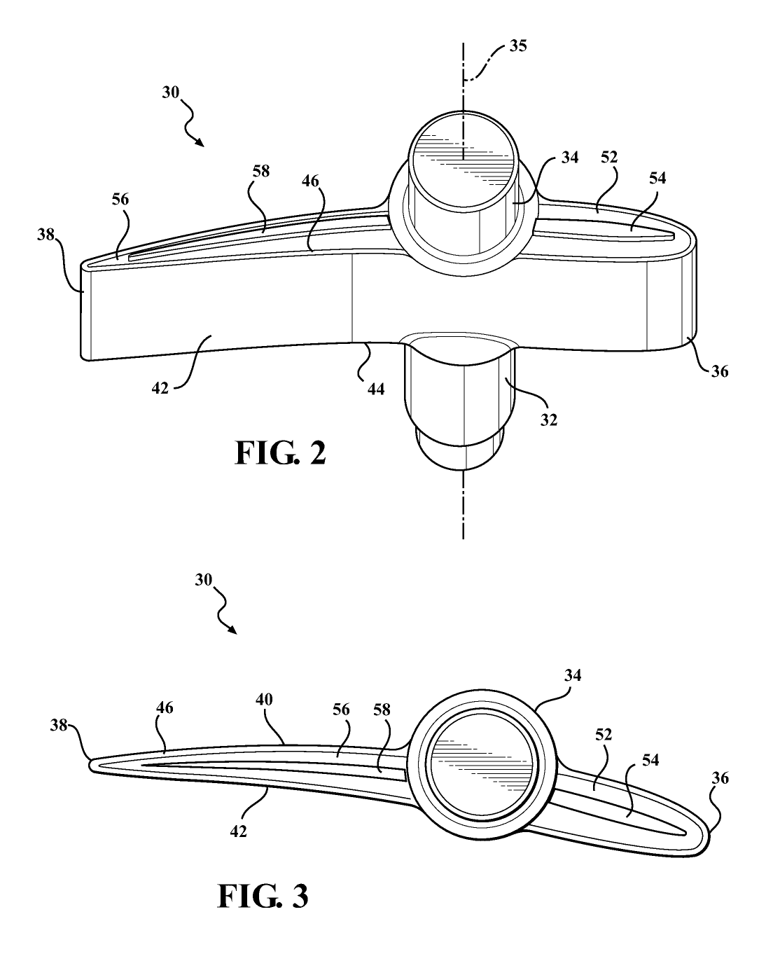

Referring to FIGS. 2 and 3, each vane 30 has the shape of an airfoil, including a pair of opposed aerodynamically-shaped flow-directing surfaces 40, 42 that extend between a rounded leading edge 36 and an opposed, rounded trailing edge 38 that are tapered relative to a mid-region 39 of the vane 30. In addition, each vane 30 has opposed, parallel side faces 44, 46 that extend between the flow-directing surfaces 40, 42. The vanes 30 are arranged in a circular array around the turbine wheel 12, and are located between the turbine volute 10 and the turbine wheel 12. The vanes 30 are pivotably supported in this configuration between a generally annular upper vane ring 80 and a generally annular lower vane ring 90, and each vane 30 is oriented so that the exhaust gas impinges on the leading edge 36 before the trailing edge 38.

Each vane 30 rotates on a pair of opposing posts 32, 34 that protrude from the opposed side faces 44, 46 of the vane 30, with the posts 32, 34 having a common axis 35. A free end of each post 32, 34 is received in a respective aperture in the lower vane ring 90 and the upper vane ring 80. The angular orientation of the upper vane ring 80 relative to the lower vane ring 90 is set such that the corresponding apertures in the vane rings 80, 90 are concentric with the axis 35 of the posts 32, 34, and the vane 30 is free to rotate about the axis 35 of the posts 32, 34. Each post 32 on the upper vane ring-side of the vane 30 protrudes through corresponding aperture of the upper vane ring 80 and is affixed to a vane arm 84, which controls the rotational position of the vane 30 with respect to the vane rings 80, 90. Typically, there is a separate actuating ring 86 which controls all of the vane arms 84 in unison. The actuating ring 86 is controlled by an actuator (not shown) which is operatively connected to rotate the actuating ring 86 via a linkage 88 (FIG. 1). The actuator is typically commanded by the engine electronic control unit (ECU). The assembly consisting of the plurality of vanes 30, the upper vane ring 80 and the lower vane ring 90 is referred to as the vane pack.

In a vane pack, the clearance between the side faces 44, 46 of the vanes 30 and the inner surfaces 82, 92 of the upper and lower vane rings 80, 90, is a major contributor to a loss of efficiency in both the control of exhaust gas allowed to impinge on the turbine wheel 12 and in the generation of backpressure upstream of the turbine wheel 12. Minimizing the clearances between the vane side faces 44, 46 and the complementary inner surfaces 82, 92 of the vane rings 80, 90 increases the efficiency of the vane pack, and thus the turbocharger 1. However, minimizing such clearances can be difficult. Because the turbine housing 4 is not symmetrically round in a radial plane, and because the heat flux within the turbine housing 4 is also not symmetrical, the turbine housing 4 is subject to asymmetric stresses and asymmetric thermal deformation. Thermal deformation in the turbine housing 4 is transferred to the vane pack, which can cause the vane pack to wear, stick, or completely jam. In addition, the materials used in the components of the vane pack tend to creep (e.g., flow, deform) over the service life of the turbocharger 1 as a result of the long-term exposure to high levels of stress and high temperatures within the turbocharger 1. As is well known, creep increases with temperature, and is more severe in materials that are subjected to heat for long periods. Thus, the vane pack must be configured to maximize efficiency by minimizing clearance between the vanes 30 and the upper and lower rings 80, 90, while also accommodating thermal expansion and creep in such a way as to prevent lock-up of the vane pack, and extend the longevity of the turbocharger 1.

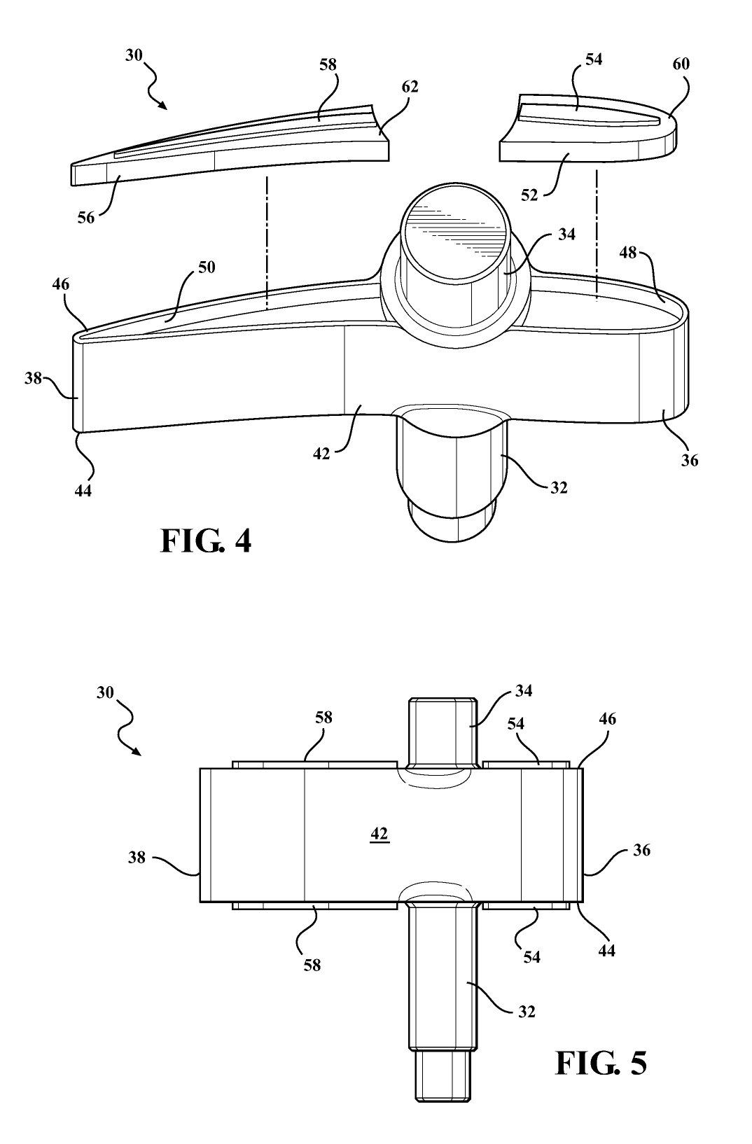

Referring also to FIGS. 4 and 5, to this end, each of the opposed side faces 44, 46 of the vanes 30 are formed having cavities 48, 50 that receive and support abradable inserts 52, 56. The inserts 52, 56 protrude outwardly from the respective side faces 44, 46 toward the vane rings 80, 90 such that the clearance between the side faces 44, 46 of the vanes 30 and the inner surfaces 82, 92 of the upper and lower vane rings 80, 90 is minimal or nil, as discussed further below.

The configuration of the first vane side face 44 is the same as that of the second, opposed side face 46, and thus only the configuration of the second vane side face 46 will be described. The vane side face 46 includes a first cavity 48 that is located between the post 32 and the vane leading edge 36, and a second cavity 50 that is located between the post 32 and the vane trailing edge 38. The first cavity 48 has a peripheral shape such that when the vane 30 is seen in side view, the peripheral shape of the first cavity 48 corresponds to the peripheral shape of the portion of the vane 30 between the post 32 and the vane leading edge 36. Similarly, the second cavity 50 has a peripheral shape such that when the vane 30 is seen in side view, the peripheral shape of the second cavity 50 corresponds to the peripheral shape of the portion of the vane 30 between the post 32 and the vane trailing edge 38. The first and second cavities 48, 50 are dimensioned such that the vane side face 46 defines a thin wall that surrounds each cavity 48, 50.

A first abradable insert 52 is disposed in the first cavity 48, and a second abradable insert 56 is disposed in the second cavity 50. Each of the inserts 52, 56 are configured to conform to the shape of the respective cavity 48, 50 such that the cavity 48, 50 is filled by the insert 52, 56, and such that at least a portion of the insert 52, 56 protrudes outwardly relative to the vane side face 46. In the illustrated embodiment, a peripheral edge of an outward-facing surface 60, 62 of each insert 52, 56 lies flush with the vane side face 46. In addition, each insert 52, 56 has a ridge 54, 58 that extends outward from the respective outward-facing surface 60, 62. Each ridge 54, 58 is elongated, and lies on a line that extends between the vane leading and trailing edges 36, 38 and generally mid-way between the opposed flow-directing surfaces 40, 42.

As a result, each ridge 54, 58 is spaced apart from the peripheral edge of the outward-facing surface 60, 62 of the insert 52, 56.

By forming the inserts 52, 56 so that they protrude outward relative to each of the vane side faces 44, 46, a minimal or nil clearance can be established between each of the vane side faces 44, 46 and the corresponding inner surface 82, 92 of the vane rings 80, 90. In some embodiments, the vanes 30 can be assembled with the upper and lower vane rings 80, 90 with an interference fit between the ridge 54,58 and the facing inner surfaces 82, 92 of the upper and lower vane rings 80, 90. Before the vane pack is installed in the turbine housing 4, the vane pack may be installed in a fixture and subjected to vibration or oscillations. In this way, the vane ring inner surfaces 82, 92 can engrave the respective inserts 52, 56 and can establish an essentially zero or very small clearance therebetween while still allowing the vanes 30 to properly function during turbocharger operation.

During turbocharger operation, the small clearance will minimize the leakage of exhaust gas flow through the space between the vane side faces 44, 46 and the vane ring inner surfaces 82, 92, thereby improving efficiency and performance. Further, it will be appreciated that if the clearance between the vane side faces 44, 46 and the vane ring inner surfaces 82, 92 is reduced during turbocharger operation, for example due to thermal expansion or creep, the vanes 30 may come into contact with the abradable inserts 52, 56. In such case, the vane ring inner surfaces 82, 92 can further wear away the abradable inserts 52, 56 without substantially impeding the function of the vanes 30, whereby turbocharger longevity may be increased.

The inserts 52, 56 may be secured within the corresponding cavity via press fitting, brazing, welding or other suitable methods.

In the illustrated embodiment, the ridge 54, 58 is formed of the same abradable material as the remainder of the insert 52, 56. However, in other embodiments, the portion of the insert 52, 56 corresponding to the ridge 54, 58 is formed of a first abradable material, and the remainder of the insert 52, 56 is formed of a second abradable material that is different from the first abradable material. In still other embodiments, the portion of the insert 52, 56 corresponding to the ridge 54, 58 is formed of an abradable material, and the remainder of the insert 52, 56 is formed of a non-abradable material.

The abradable material used to form the inserts 52, 56 can be any material suitable for long-term use in a high temperature and high stress environment, and that can abrade during contact between the vane side faces 44, 46 and the inner surfaces 82, 92 of the vane rings 80,90.

Examples of suitable abradable materials include aluminium silicon alloy/polymer composites, aluminium silicon alloy/graphite composites, nickel/graphite composites, aluminium bronze/polymer composites, nickel chromium aluminium/boron nitride composites, nickel chromium aluminium/bentonite composites, nickel/aluminium composite sprayed porous, nickel chromium aluminium composite sprayed porous, MCrAlY/BN/Polyester composites and Yttria-stabilized zirconia (YSZ) ceramic/Polyester composites. In one embodiment, the abradable material can be a zirconia-polymer ceramic abradable powder. Such a powder can be formed to the desired shape and dimensions by, for example, thermal spraying into a mold. Examples of other suitable materials include DURABLADE 2192, Sulzer Metco 2395 and/or Sulzer Metco 2460NS, which are available from Sulzer Metco (US) Inc., Westbury, N.Y. Further suitable abradable materials include TECH 17, TECH 28 and/or TECH 40, which are available from Bodycote K-Tech Ltd., Cheshire, England. Materials similar to those listed above may also be suitable. However, embodiments are not limited to any particular material.

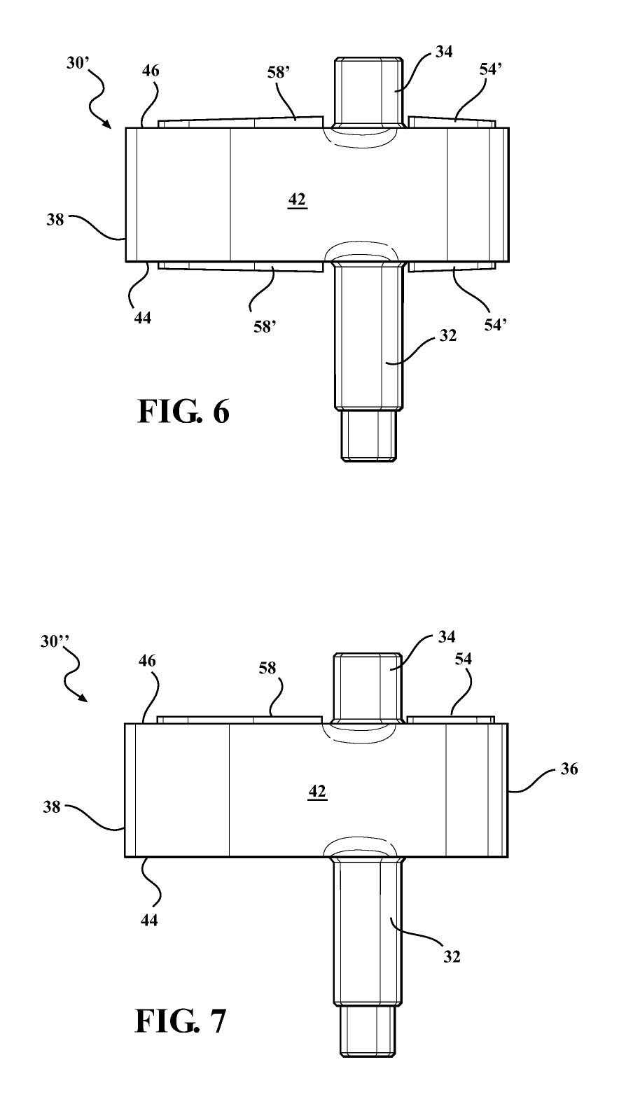

Although the inserts 52, 56 are illustrated in FIG. 5 as has having ridges 54, 58 of uniform height, the inserts 52, 56 are not limited to this configuration. For example, in some embodiments, the ridge 54, 58 may be formed so as to protrude outwardly to a lesser extent in locations adjacent to the vane leading edge 36 or the vane trailing edge 38 when compared to an extent of outward protrusion in a region mid-way between the vane leading and trailing edges 36, 38 (FIG. 6).

In addition, in the embodiment illustrated in FIGS. 2-5, the inserts 52, 56 that are provided on the first side face 44 of the vane 30 are substantially identical to the inserts 52, 56 provided on the second side face 46 of the vane 30. However, the vanes 30 are not limited to this configuration. In one example, the inserts 52, 56 provided on the first side face 44 may be formed of different material(s) than the inserts 52, 56 provided on the second side face 46. In addition, or alternatively, the inserts 52, 56 provided on the first side face 44 may be formed having different dimensions (i.e., may protrude to a different extent) than the inserts 52, 56 provided on the second side face 46. In another example, one vane side surface (i.e., the vane first side face 44) may be formed without cavities 48, 50 and/or inserts 52, 56, while the opposed vane side surface (i.e., the vane second side surface 46) may be formed having cavities 48, 50 and inserts 52, 56 disposed in the cavities as described above (FIG. 7).

Although the inserts 52, 56 as described herein have the peripheral edge of the outward-facing surface 60, 62 of each insert 52, 56 configured to lie flush with the vane side face, the inserts 52, 56 are not limited to this configuration. For example, in some embodiments, the peripheral edge may also protrude relative to the vane side face to the same extent, or a lesser extent, than the ridges 54, 58.

Although the cavities 48, 50 and the inserts 52, 56 are described as having a peripheral shape such that when the vane 30 is seen in side view, the peripheral shape of the cavities 48, 50 and the inserts 52, 56 corresponds to the peripheral shape of at least a portion of the vane 30, the cavities 48, 50 and the inserts 52, 56 are not limited to this shape. For example, in some embodiments, the cavities 48, 50 and the inserts 52, 56 are formed having an oval or polygonal peripheral shape.

Although the vanes 30 are described as having the shape of an airfoil, the vanes 30 are not limited to this shape including the shape and/or proportions illustrated herein. For example, the vanes 30 may have an airfoil shape of different proportions (e.g., a “chubby” vane).

In another example, the vanes 30 may have a generally oval, polygonal or other non-airfoil shape.

In some embodiments, the first and second cavities 48, 50 on each side face 44, 46 may be replaced with through holes that extend between the opposed side faces 44, 46, and an insert can be provided in each through hole. In these embodiments, each insert protrudes from both opposed sides of the vane 30.

Aspects described herein can be embodied in other forms and combinations without departing from the spirit or essential attributes thereof. Thus, it will of course be understood that embodiments are not limited to the specific details described herein, which are given by way of example only, and that various modifications and alterations are possible within the scope of the following claims.

1. A variable geometry turbine comprising:
a turbine housing that defines a volute and a fluid outlet;
a turbine wheel disposed in the turbine housing between the volute and the fluid outlet ;
a first vane ring and a second vane ring disposed between the volute and the turbine wheel such that a fluid flow passageway is defined between a surface of the first vane ring and a surface of the second vane ring, and
vanes that are each pivotably supported between the surface of the first vane ring and the surface of the second vane ring, each vane including
opposed side faces,
a cavity formed in one of the side faces, and
an abradable insert disposed in the cavity, the insert protruding outward from the cavity whereby a minimal clearance is established between the one of the side faces and a corresponding one of the surface of the first vane ring and the surface of the second vane ring.

2. The variable geometry turbine of claim 1, wherein each vane includes a cavity in each of the opposed side faces, and an outwardly protruding abradable insert is disposed in each cavity.

3. The variable geometry turbine of claim 1, wherein the cavity has a peripheral shape such that when the vane is seen in side view, the peripheral shape of the cavity corresponds to the peripheral shape of at least a portion of the vane.

4. The variable geometry turbine of claim 1, wherein each vane includes a post that extends outward from the one of the opposed side faces,
the cavity is disposed between the post and a leading edge of the vane,
a second cavity is disposed between the post and a trailing edge of the vane, and
a second abradable insert is disposed in the second cavity.

5. The variable geometry turbine of claim 1, wherein
the insert is configured to conform to the shape of the cavity such that the cavity is filled by the insert, and
the insert includes a ridge that extends outward from an outward-facing surface of the insert.

6. The variable geometry turbine of claim 5, wherein a peripheral edge of the outward-facing surface of the insert lies flush with the one of the side faces of the vane.

7. The variable geometry turbine of claim 5, wherein the ridge is elongated and lies on a line that extends between a leading edge of the vane and a trailing edge of the vane.

8. The variable geometry turbine of claim 5, wherein the ridge is spaced apart from a peripheral edge of the outward-facing surface of the insert.

9. The variable geometry turbine of claim 5, wherein the portion of the insert corresponding to the ridge is formed of a first material, and a remainder of the insert is formed of a second material, where the first material is different from the second material.

10. The variable geometry turbine of claim 5, wherein the ridge protrudes outwardly to a lesser extent in locations adjacent to a leading edge of the vane or a trailing edge of the vane when compared to an extent of outward protrusion in a region midway between the leading edge of the vane and the trailing edge of the vane.

11. A turbocharger comprising
a compressor including a compressor wheel, and
a variable geometry turbine, the turbine including
a turbine housing that defines a volute and a fluid outlet;
a turbine wheel disposed in the turbine housing between the volute and the fluid outlet, the turbine wheel connected to the compressor wheel via a shaft;
a first vane ring and a second vane ring disposed between the volute and the turbine wheel such that a fluid flow passageway is defined between a surface of the first vane ring and a surface of the second vane ring, and
vanes that are each pivotably supported between the surface of the first vane ring and the surface of the second vane ring, each vane including
opposed side faces,
a cavity formed in one of the side faces, and
an abradable insert disposed in the cavity, the insert protruding outward from the cavity whereby a minimal clearance is established between the one of the side faces and a corresponding one of the surface of the first vane ring and the surface of the second vane ring.
